(19) United States
(12) Patent Application Publication
(10) Pub. No.: US 2018/0276777 A1
(43) Pub. Date: Sep. 27, 2018

(54) INTELLIGENCE BASED METHOD AND PLATFORM FOR AGGREGATING, STORING AND ACCESSING FOOD SAFETY COURSES, CONTENT AND RECORDS

(71) Applicant: Tina Brillinger, Toronto (CA)

(72) Inventor: Tina Brillinger, Toronto (CA)

(21) Appl. No.: 15/919,599

(22) Filed: Mar. 13, 2018

Related U.S. Application Data
(60) Provisional application No. 62/475,822, filed on Mar. 23, 2017.

(51) Int. Cl. G06Q 50/20; G06F 17/30; G06Q 20/12; G06Q 30/00; G09B 19/00; G09B 5/06

(52) U.S. Cl. CPC G06Q 50/2057; G06F 17/30893; G06Q 20/123; G06F 3/04842; G09B 19/0092; G09B 5/065; G06Q 30/018

(57) ABSTRACT

A method and platform for providing access to a plurality of food safety related course, content and resources. The computer program product embodiment has a front end for user access and a back end being a repository for a plurality of food safety courses, content or links thereto. The front end is coupled to the back end over a transport facility, the front end having a user interface. The invention further comprises an analytics engine coupled between the front end and the back end for analyzing data received from the end user and based thereon, filtering which of the plurality of food safety courses, content or links are most appropriate for the end user. The invention uses blockchain technology to secure end user records and certifications.

### CROSS-REFERENCE TO RELATED APPLICATION

This application claims priority to U.S. Provisional Patent Application Ser. No. 62/475,822, filed Mar. 23, 2017 entitled: METHOD AND PLATFORM FOR AGGREGATION OF FOOD SAFETY TRAINING DATA AND EDUCATIONAL CONTENT, the contents of which are incorporated herein by reference.

### FIELD OF THE INVENTION

The invention relates to suggestion algorithms as applied to computer-based platforms for accessing data and educational content related to food safety.

### BACKGROUND

Given the globalization of food, consumers are at a greater risk to be affected by the food they eat through contamination. In the United States the Center for Disease Control (CDC) has determined 48 million Americans are sickened every year from contaminated food. In the United Kingdom, more than 270,000 individuals are sickened by Campylobacter which is considered to be the most common bacterial cause of human gastroenteritis in the world. As a result of high profile recalls, some involving thousands of illnesses and even deaths, consumers are demanding safer food products. It is estimated that approximately 68% of consumers have concerns about the food they eat. In countries like China where regulations are lax or even non-existent there is an even greater concern as many of the food items are adulterated but sold at a premium.

In the past, food companies and their suppliers/distributors who knowingly sold contaminated or adulterated food would often deal with adverse food events reactively. Even when individuals were sickened many food companies escaped significant fines for non-compliance. New laws are emerging to protect consumers, under which food companies are at greater risk of being held criminally responsible and civilly liable for damages.

Prior to the widespread adoption of social media, food companies and their suppliers and distributors were able to hide out of sight of the public. With the advent of social media, consumers are able to report issues immediately which can go viral. Companies and their products can be named publicly, whether they are liable or not, which can damage their brand and cost them or their industry significant amounts in revenue. In many instances, the events can even adversely affect the brand of an entire country as consumers avoid purchasing products from a country whose food supply is perceived to be unsafe or a health risk.

In 2016, the Food Safety Modernization Act (FSMA) was enacted in the United States. One of the mandates under the FSMA is that companies must ensure their employees have been properly trained and must be able to demonstrate this through certification documentation.

Given the scope and demand for training that harmonizes with new regulations, companies must invest in training with a view towards building a safe food culture where there is a greater emphasis on food safety.

Given the technological advances of the internet and readily available access through desktops, laptops and smartphone devices, companies can encourage and incentivize employees to take mandated training on any day of the week and at any time of day.

According to “Field Guide to Learning Management Systems”, Ellis, Ryann K. (2009), a learning management system (LMS) is a software application for the administration, documentation, tracking, reporting and delivery of educational courses or training programs. They help the instructor deliver material to the students, administer tests and other assignments, track student progress, and manage record-keeping. LMSs support a range of uses, from supporting classes that meet in physical classrooms to acting as a platform for fully online courses, as well as several hybrid forms, such as blended learning and flipped classrooms.

According to “Making e-learning effective,” Gilhooly, Kym (16 Jul. 2001), and “CMI Theory and Practice: Historical Roots of Learning Management Systems”, Szabo, Micheal; Flesher, K. (2002), an LMS delivers and manages instructional content, and typically handles student registration, course administration, and tracking, and reporting of student work. Some LMSs help identify progress towards learning or training goals. Most LMSs are web-based, to facilitate access. LMSs are often used by regulated industries for compliance training. Some LMS providers include “performance management systems”, which encompass employee appraisals, competency management, skills-gap analysis, succession planning, and multi-rater assessments (i.e., 360 degree reviews). Some systems support competency-based learning.

Though there are a wide variety of terms for digital aids or platforms for education, such as course management systems, virtual or managed learning platforms or systems, or computer-based learning environment, the term learning management system has become the ubiquitous term for products that help administer or deliver part or ail of a course.

Conventionally, companies and food professionals provide online training to end users through proprietary websites and market referrals but there is no single, centralized hub that aggregates training that can meet most or all of the varied needs of the food industry. In computer science and machine learning, decision trees are well-known algorithms comprising a series of conditional control statements which are navigated by testing or evaluating known information against said conditional statements, each evaluation creating a new branching path, each branch terminating at a decision or result. They are an efficient way to separate, sort, group, and/or categorize data structures or objects having multiple attributes.

According to Wikipedia, a blockchain is a continuously growing list of records, called blocks, which are linked and secured using cryptography. Each block typically contains a cryptographic hash of the previous block, a timestamp and transaction data. By design, a blockchain is inherently resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

What is desired is a platform managed by a platform manager that uses novel machine learning algorithms that provide readily accessible competency-based training from a plurality of third party training providers, the platform operable to improve food safety systems thus improving customer health, while reducing their risk of end user liability, the records of the platform being secured using blockchain technology.

### SUMMARY OF THE INVENTION

The invention is a system and method comprised of an analytics engine, training repository, client access module and blockchain secured repository operating as a safe food training hub (SFTH) platform. The SFTH platform is a novel global catalogue and aggregation of industry recognized food safety training content offered, for sale or otherwise, by universities, private companies, NGO's and associations (referred to as training providers) which is curated for end-users based on self-identified attributes by way of a suggestion algorithm performed by an analytics engine. Using the invention, food professionals and employees of companies can also filter courses by type, date, kind, language, industry sector, food category, job competency, private-fee based, end-user location, open-source or pay-access, company name or keyword.

### BRIEF DESCRIPTION OF THE DRAWINGS

Other features of the invention will become clear from the following description, taken together with the accompanying drawings.

FIG. 1 lays out a high-level system architecture in one embodiment of the present invention.

FIG. 2 shows an example of a decision-tree algorithm having multiple branches being applied to course suggestion in one embodiment of the present invention.

FIG. 3 is a flowchart showing one example of an end-user interaction sequence with one embodiment of the present invention.

FIG. 4 presents one embodiment of the front-end user interface of the present invention.

FIG. 5 presents one embodiment of a front-end course creation page interface of the present invention.

FIG. 6 is a flowchart showing a sequence of laying out the system architecture of one embodiment of the present invention.

### DETAILED DESCRIPTION

While the making and using of the preferred embodiments of the present invention is discussed in detail below, it should be appreciated that the present invention provides many applicable inventive concepts which can be embodied in a wide variety of specific contexts. Some features of the preferred embodiment shown and discussed may be simplified or exaggerated for illustrating the principles of the invention.

The invention comprises an analytics engine, a back-end data repository secured using local or global blockchain technology and a front-end client access module, said invention operating as a safe food training hub (SFTH) platform. The SFTH platform is a novel global catalogue and aggregation of data, content and links to industry recognized food safety courses offered, for sale or otherwise, by universities, private companies, NGO's and associations (referred to as training providers). Using the invention, food professionals and employees of companies (referred to as end users) are served access to content selected by an analytics engine that is operable to filter courses by type, date, kind, language, industry sector, food category, job competency, company name, rating, or keyword, end-user location, or by whether they are private-fee based or open-sourced. The SFTH platform can be configured to interface to other features including a calendar of courses, star-rating, peer reviewed rating, marketing enhancements for placement and enhanced visual awareness.

The SFTH platform includes an e-commerce and royalty sharing component for compensating training providers and is multilingual for an international end-user audience. Aggregate content in the SFTH platform is reviewed and approved by technical experts to ensure the content is accurate and identifies the competencies and outcomes of the training for the end user. The SFTH platform aggregates data, content and links that is then filtered to a user using the analytics engine. This allows companies to upload their training courses to the SFTH hosted platform and/or provide links to a plurality of LMS training providers, LMS, third party repositories or websites where the courses are located, the SFTH platform then filters appropriate content to an end user via this single point of access. In addition to the course content, training providers will be able to upload supporting content including but not limited to videos, white-papers, ebooks, checklists, and toolkits. Records about which course content a user has accessed are secured using local or global blockchain technology.

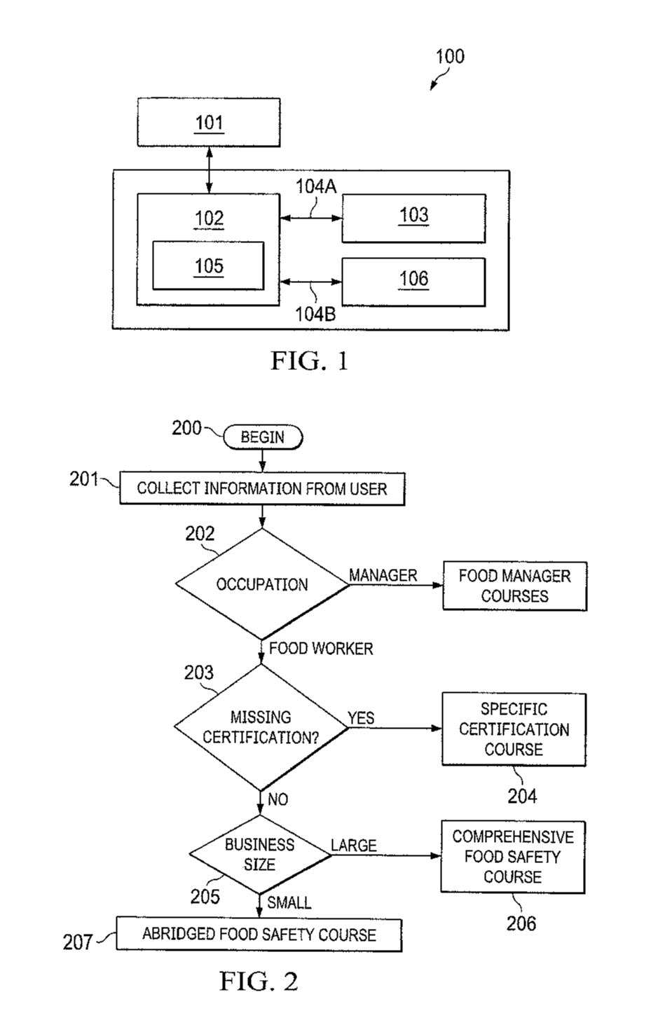

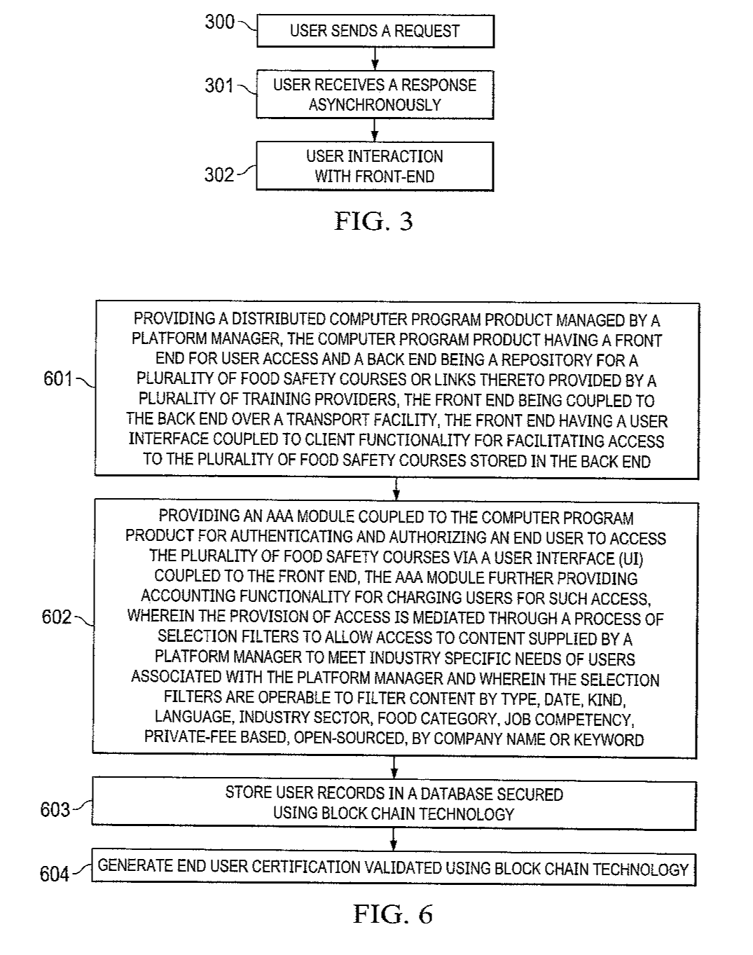

The invention 100 comprises a front-end for client access, a back end repository 103 for storing content and resources, the path between the front end and back end being mediated by an analytics engine. Referring to FIG. 1, all communications between the front-end client access module 101 and the back-end data repository 103 is accomplished via API calls 104A, 104B from the SFTH platform 102. The end user uses the front end user interface 101 to communicate with the SFTH platform 102 by sending a request to the SFTH platform 102. The end user is authenticated and authorized and then receives a response asynchronously from the SFTH platform 102. These steps are seen in FIG. 3. As seen therein, the end user uses the front end user interface 101 to communicate with the SFTH platform 102 by sending a request to the SFTH platform in step 301. The end user is authenticated and authorized and then receives a response asynchronously from the SFTH platform 102 in step 302. Records setting forth which course content a user has accessed and viewed and user certifications are maintained and secured in database 106 using local or global blockchain technology. The invention is operable to generate end user certifications based on the end user records. The end user certifications are validated using blockchain technology. For example, using a serialized number issued by GS1 on the end user certificate and time stamped ensures transparency, validation and integrity for those who have completed training through the SFTH platform. GS1 US is a standards organization supporting and educating businesses and industries in the use and adoption of GS1 standards to improve business processes. The analytics engine of the invention is further operable to access end user records and end user certifications to further filter the food safety courses and content to be made available to an end user.

The authentication and authorization uses, for example, a challenge and response protocol to an authentication and authorization database or server which may reside on the SFTH platform 102 or externally. Once authenticated and authorized, an end user can interact with the SFTH platform 102 in step 303, such interaction to include accessing selected food safety courses and content from the back end repository 103.

The SFTH platform 100 includes an analytics engine 105 operable to use at least one algorithm to determine the most appropriate courses, content and resources for a particular end user based on user input data and data retained in or received from third party repositories. The SFTH platform 100 is operable to store information about an end user, such information secured using blockchain technology, the analytics engine 105 accessing such information to further filter the food safety courses and content to be made available to an end user. For example, data stored in database 106 about prior taken and passed or failed courses is accessible by the analytics engine 105 to further inform which food safety courses or content is to be made available to the end user. Further, the laws and regulations in a jurisdiction of the end user, and any changes therein, are used by the analytics engine 105 to further tailor the food safety courses or content that is offered to an end user.

The design of the website front end is driven by user experience. The SFTH platform is comprised as a hybrid single page application. This concept consists of applications where only a single hypertext markup language (HTML) document or “page” is submitted to the client, and after the initial load, only fragments of the page are reloaded, by Ajax requests, without ever making a full page reload. The main advantage of this web application model is that, due to minimizing the data traffic between the client and the server, it provides the user with a highly dynamic application, with low “latency” between user actions on the interface.

The SFTH platform executes an algorithm to automate the tailoring of food safety curricula via suggestion of courses to end users based on self-identified attributes. In one embodiment, said algorithm is a decision tree comprising a plurality of sequential conditional statements, each branch terminating at a suggested course or curriculum. An example branch of one embodiment of said algorithm is shown in FIG. 2. The branch seen in FIG. 2 is a simplified portion of an algorithm to illustrate the nature of the invention and is not meant to be limiting. The algorithm is operable to correlate self-identified user attributes to instructional resources, said resources comprising course content, videos, white-papers, e-books, checklists, and toolkits; said algorithm is performed by an analytics engine, said analytics engine comprising software embodied as instructions stored in a computer-readable medium and executed by a processor. Said data repository comprises a computer memory in which said instructional resources are stored, and an integrated meta-tagging and mapping system which associates courses and curricula with outcomes of suggestion algorithm branches.

As seen in FIG. 2, an end-user provides information in step 201 during the registration process including but not limited to occupation, size of restaurant or business, current certifications, etc., said information being evaluated at conditional steps 202, 203 and 205, each evaluation leading to either another conditional step or an outcome 204, 206, or 207, thereby navigating a decision tree in order to identify and suggest appropriate courses and/or curricula 204, 206, 207 to said end-user. Such a conditional step/outcome algorithm is used to filter any number of food safety courses or content for an end user.

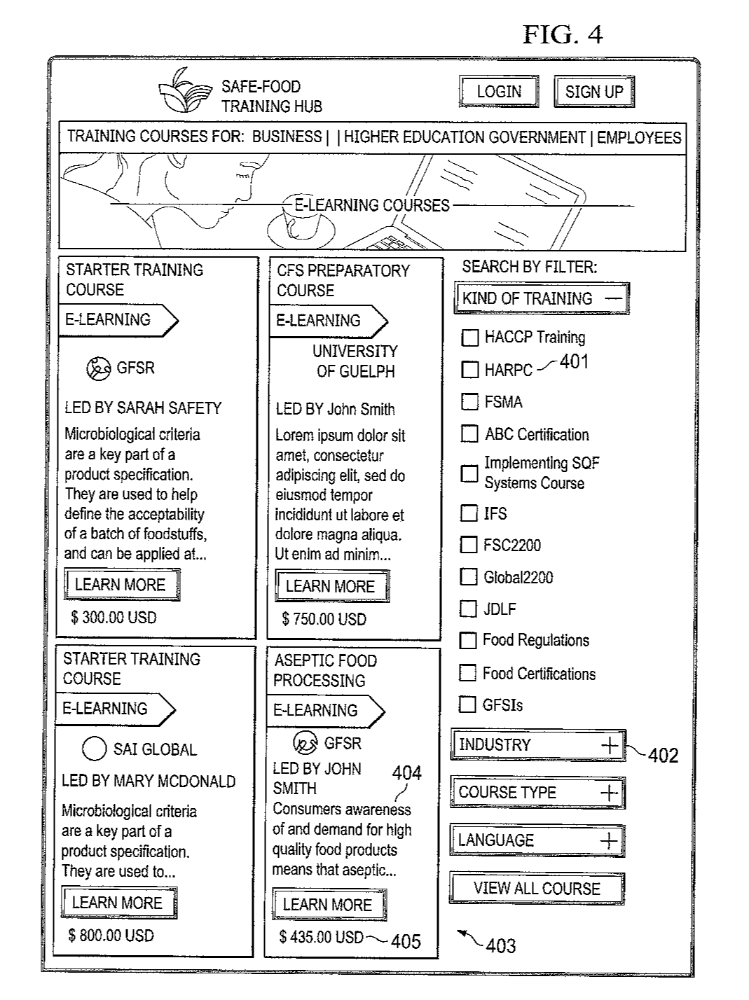

One embodiment of the front-end client access module is shown in FIG. 4. Said front-end arranges, organizes, displays, and provides links to the instructional resources 403 residing on said back-end, and facilitates the purchasing, viewing, completion and otherwise accessing of said resources. The resources displayed may be a curated set produced by a suggestion algorithm performed by said analytics engine or may be manually filtered by an end-user using common interaction means such as drop-down lists 402, radio buttons, checkboxes 401, text-entry fields and the like according to several criteria including but not limited to type, date, kind, language, industry sector, food category, job competency, company name, rating, or keyword, or by whether they are private-fee based or open-sourced.

The SFTH platform facilitates training from a plurality of sources for end users in the area of food safety to meet the demands of regulatory and industry compliance worldwide. The SFTH platform also provides a competency-based training platform to meet the new rules for preventative controls to minimize risk as laid out in new regulations worldwide. The platform allows for various food industry segments to upload their content including: food manufacturing/processing, retail, agriculture, food service and hospitality, regulatory and others. Finally, the SFTH platform facilitates training needed for food suppliers in emerging markets where there is a need for capacity building to meet the demands for food production due to a growing global population and to improve economic outcomes for people in many developing countries.

In an embodiment of the invention, the back-end repository aggregates course content from a plurality of training providers that is augmented through meta-tagging and other means to facilitate curating of said course content by said analytics engine.

Using the SFTH platform, an end user is able to register, login and have provided to them content and resources according to their needs through a selection of filters, such as: type of course (online/in-class/webinar), fee-based or open-source, geographical region, language, industry sector (e.g., dairy, poultry, agriculture, packaging), job competency, level (e.g., advanced, intermediate, basic), company name, and pricing. An end user is further able to access course content and curriculum suggestions generated or curated by said analytics engine.

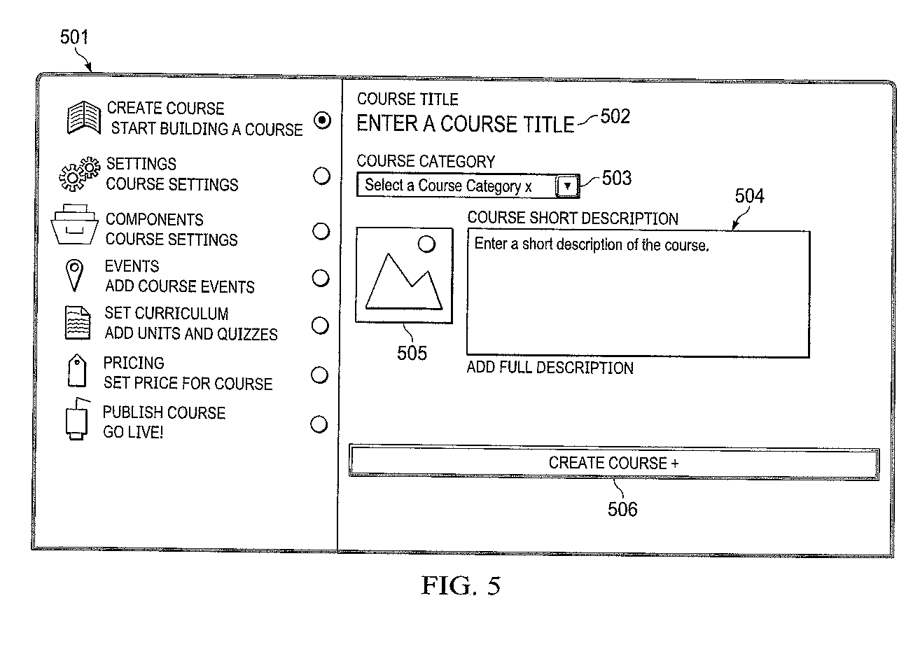

Using the SFTH platform, a content creator is able to upload or add courses to the back-end repository. Referring to FIG. 5 which shows an example of the front-end course addition interface in one embodiment of the invention, a user completes multiple steps 501 by inputting information including a course title 502, a course category 503, a course description 504, and a representative image 505, by interaction means such as text-entry fields, dropdown lists, radio buttons or checkboxes, and the like.

In operation, the end user inputs accounting, authentication and authorization (AAA) data in the front-end UI of the SFTH platform and through an assessment of certain parameters, such as the end user's company or personal training needs, the end user is provided with a front-facing interface to the SFTH platform. Referring to FIG. 4, the interface is an HTML page comprising finable fields, drop down selections 402, radio button or checkbox selections 401, and the like, enabling the end user to filter and select from a list of courses 403, complete with description 404, pricing 405 and availability, each course being available from the back-end aggregation repository via a link to a third-party repository. The SFTH platform provides access to both fee-based course content and open-source free content. In an aspect, the SFTH platform comprises a portal for food companies to monitor and track employee training. In a further aspect, the SFTH platform comprises an ability for companies to customize curricula for their employees.

In an aspect, the SFTH platform includes open education resources that public and private sector training course donors have been producing through a variety of food safety initiatives and interventions in developing countries.

The e-commerce aspect of the SFTH platform integrates payment modules through or coupled to the AAA module, the payment module such as that provided by PayPal®. The e-commerce aspect includes at least one module operable to calculate and then allocate revenue among the platform manager and the training providers. For example, training providers may receive their course fee from every seat taken and the platform manager may receive a royalty based on an agreed percentage. An interface into the SFTH platform may provide a dashboard with limited access to each training provider to review courses taken by end users and the revenue accumulated and the training provider's allocation thereof. The SFTH platform, in an aspect, includes an option for training providers to have their courses peer-reviewed for a fee by a third party. In a further aspect, the SFTH platform includes courses that are multilingual with an English description and further includes a course calendar to show which courses are available by month. In a further aspect, the SFTH platform includes a library of resources which could include standards manuals for sales/training videos and whitepapers. In a further aspect, the SFTH platform allows companies to set up quizzes and assignments or exams. In a further aspect, the SFTH platform includes an “Ask the Expert” module which provides food professionals with access to suggested online consulting services for a fee. In a further aspect, the SFTH platform includes a rating system allowing end users to rate courses, and further to rate the appropriateness of the content suggested by the analytics engine. In a further aspect, the SFTH platform includes enhanced options for marketing exposure of training courses such as premium placement by category and visual enhancement.

In a further aspect, the SFTH platform includes a module allowing a company to subscribe its employees to the platform and allow the company to monitor the courses suggested by the analytics engine and to monitor the training of their employees. In a further aspect, the SFTH platform includes a module to provide certification documents that students receive upon completion of their course.

In a further aspect, the SFTH platform includes a mobile application coupled to a user interface that is displayed on a mobile device so as to allow end users to enroll in the application, answer questions prompted by the analytics engine and search, filter and purchase courses via the mobile application.

The invention is an intelligence based centralized portal of food safety training and resources to improve outcomes for domestic and international food while ensuring competency-based skills and knowledge from quality training to enhance a culture of safe food. Advantageously, the invention facilitates the prevention of adverse food safety events which, in turn, adversely affect businesses and consumers. The SFTH platform further comprises a comprehensive registry and database of global food safety training available to end users through a dynamic and responsive user-friendly platform.

The invention can be further tailored to facilitate intelligence based access to content and resources by end users including, but not limited to, farmers, processors, regulators, food service operators and other stakeholders in food value chains. The invention is a tool that assists such end users in meeting stringent international and national food safety regulations and industry specifications and standards thus reducing public health risks to consumers by tailoring access to content specific to their needs.

In an embodiment, the invention comprises a method of providing access to a food safety course, comprising the steps of providing a distributed computer program product having a front end for user access, an analytics engine for filtering access to content and resources, and a back end being a repository for a plurality of food safety courses, the front end being coupled to the back end over a transport facility, the front end having a user interface coupled to client functionality for facilitating access to the plurality of food safety courses stored in the back end; and providing an AAA module coupled to the computer program product for authenticating and authorizing users to access the plurality of food safety courses via a User Interface (UI) coupled to the front end, the AAA module further providing accounting functionality for charging users for such access.

In an embodiment, the provision of access is mediated through a process of selection filters to allow access to content supplied by a platform manager to meet industry specific needs of users associated with platform manager. The selection filters are operable to filter courses by type, date, kind, language, industry sector, food category, job competency, private-fee based, open-sourced, by company name or keyword. The invention can also be configured to interface to other features including like a calendar of courses, star-rating, peer reviewed rating, marketing enhancements for placement and enhanced visual awareness. The computer program includes an analytics engine operable to determine the most appropriate courses, content and resources for a particular user based on user input data and data retained in or received from third party repositories. The platform is operable to store information about an end user, the analytics engine accessing such information to further filter the food safety courses and content to be made available to an end user. For example, data about prior taken and passed or failed courses is accessible by the analytics engine to further inform which food safety courses or content is to be made available to the end user. Further, the laws and regulations in a jurisdiction of the end user, and any changes therein, are used by the analytics engine to further tailor the food safety courses or content that is offered to an end user.

In a further embodiment, the front end is coupled to the back end using two-way data binding. The invention further comprises the step of establishing accounting terms between the platform manager and training provider whereby the training provider provides food safety courses to be accessed via the back end. Further steps of the method include paying, by a user, via the UI and the AAA module, a predetermined rate for access to a food safety course, sending payment data to a revenue share software module within the computer program product, sending, by the revenue share software module, a portion of the predetermined rate to the training provider and retaining by the platform manager the remainder; and allowing access of the selected food safety course by the user. In an aspect of the invention, the end user has access to the food safety course in a variety of online or in-class formats. As seen in steps 601 and 602 of FIG. 6: The invention is operable to provide a distributed computer program product managed by a platform manager, the computer program product having a front end for user access and a back end being a repository for a plurality of food safety courses or links thereto provided by a plurality of training providers, the front end being coupled to the back end over a transport facility, the front end having a user interface coupled to client functionality for facilitating access to the plurality of food safety courses stored in the back end. The invention is further operable to providing an AAA module coupled to the computer program product for authenticating and authorizing an end user to access the plurality of food safety courses via a User Interface (UI) coupled to the front end, the AAA module further providing accounting functionality for charging users for such access, wherein the provision of access is mediated through a process of selection filters to allow access to content supplied by a platform manager to meet industry specific needs of users associated with the platform manager and wherein the selection filters are operable to filter content by type, date, kind, language, industry sector, food category, job competency, private-fee based, end-user location, open-source or pay-access, company name or keyword. The selection filter is embodied within the analytics engine of the invention. In step 603, records setting forth which course content a user has accessed and viewed are maintained and secured in database using blockchain technology. In step 604, end user records are used to generate end user certifications that are validated using block chain technology. The block chain can be generated locally with reference to local database data or generated globally using externally based data. For example, using a serialized number issued by GS1 on the end user certificate and time stamped ensures transparency, validation and integrity for those who have completed training through the SFTH platform. GS1 US is a standards organization supporting and educating businesses and industries in the use and adoption of GS1 standards to improve business processes.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

An embodiment of the invention may be an article of manufacture in which a non-transitory machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

The embodiments shown and described herein are only exemplary. Even though characteristics and advantages of the present invention have been set forth in the foregoing description together with details of the invention, the disclosure is illustrative only and changes may be made within the principles of the invention to the full extent indicated by the broad general meaning of the terms used in the attached claims.

What is claimed is:

1. A method of providing access to a plurality of resources, comprising the steps of:
providing a distributed computer program product, the computer program product having a front end for end user access and a back end being a repository for a plurality of food safety courses, content or links thereto provided by a plurality of training providers, the front end being coupled to the back end over a transport facility, the front end having an end user interface;
providing an analytics engine coupled between the front end and the back end for analyzing data received from the end user and based thereon, filtering which of the plurality of food safety courses, content or links are most appropriate for the end user;
providing from the back end such filtered food safety courses, content or links to the end user through the front end;
generating an end user record setting forth which course content an end user has accessed and viewed;
storing the end user record in an end user database; and
securing the end user record using a blockchain technology.

2. The method of claim 1, further comprising the step of providing an AAA module coupled to the computer program product for authenticating and authorizing an end user to access the filtered food safety courses, content or links via a User Interface (UI) coupled to the front end, the AAA module further providing accounting functionality for charging users for such access.

3. The method of claim 1, wherein the provision of access is mediated by the analytics engine using a process of selection filters to allow access to food safety courses, content or links supplied by a platform manager to meet industry specific needs of users associated with the platform manager.

4. The method of claim 3, wherein the selection filters are operable to filter content by type, date, kind, language, industry sector, food category, job competency, private-fee based, end-user location, open-source or pay-access, company name or keyword.

5. The method of claim 1, further comprising the step of interfacing the computer program product to at least one of a calendar of courses, star-rating system, peer reviewed rating.

6. The method of claim 1, wherein the front end is coupled to the back end using two-way data binding.

7. The method of claim 1, further comprising the steps of:
paying, by the end user, via the UI and the AAA module, a predetermined rate for access to at least one food safety course, content or link filtered by the analytics engine;
sending payment data to a revenue share software module within the computer program product;
sending, by the revenue share software module, a portion of the predetermined rate to the training provider and retaining by a platform manager the remainder; and
thereafter allowing access of the filtered food safety course by the end user.

8. The method of claim 7, further comprising the step of providing end user access to the filtered food safety course or content in one of an online course or in-class format.

9. The method of claim 1, wherein the computer program product generates end user certifications based on end user records, the end user certification being validated using blockchain technology; and
the analytics engine accesses end user records and end user certifications to further filter the food safety courses and content to be made available to an end user.

10. An intelligence based platform for aggregating food safety courses and content comprising:
a non-transitory machine-readable medium having computer code stored therein, operable to be executed by a set of one or more processors of a network device communicatively coupled to a repository of food safety courses or content;
a front end user interface for receiving input from an end user related to certain characteristics of the end user;
a selection filter of an analytics engine configured to operate on the input of the end user to determine the most appropriate food safety courses or content for said end user;
a repository operable to store or provide links to a plurality of food safety courses or content; and
the front end user interface configurable to display the filtered food safety courses or content.

11. The intelligence based platform of claim 10, further comprising an end user database for storing an end user record of which course content an end user has accessed and viewed, said end user database secured using blockchain technology.

12. The intelligence based platform of claim 11, further comprising a certification engine operable to access end user records to generate an end user certification, the end user certification being validated using blockchain technology.

13. The intelligence based platform of claim 10, wherein the selection filter of the analytics engine is operable to filter food safety courses and content by type, date, kind, language, industry sector, food category, job competency, private-fee based, end-user location, open-source or pay-access, company name or keyword.

14. The intelligence based platform of claim 10, further comprising an authentication and authorization module for authenticating and authorizing an end user to access the filtered food safety courses, content or links.

15. The intelligence based platform of claim 10, further comprising a calendar module operable to schedule a course for an end user.

16. The intelligence based platform of claim 10, further comprising a rating module operable to receive and aggregate user or peer ratings for the various food safety courses or content.

17. The intelligence based platform of claim 10, wherein the computer code is operable to store information about an end user, the analytics engine accessing such information to further filter the food safety courses and content to be made available to an end user.

18. The intelligence based platform of claim 17, wherein the computer code is operable to store data about prior taken and passed or failed courses and provide such data to the analytics engine to further inform which food safety courses or content is to be made available to the end user.

19. The intelligence based platform of claim 17, wherein the computer code is operable to store data about the laws and regulations in a jurisdiction of the end user, and any changes therein, and provide such data to the analytics engine to further inform which food safety courses or content is to be made available to the end user.

20. A computer program product for aggregating food safety courses and content comprising:
a front end user interface for receiving input from an end user related to certain characteristics of the end user and to display filtered food safety courses or content;
an analytics engine configured to operate on the input of the end user and external third party data to determine the most appropriate food safety courses or content for said end user, wherein the analytics engine includes a selection filter operable to filter food safety courses and content by type, date, kind, language, industry sector, food category, job competency, private-fee based, end-user location, open-source or pay-access, company name or keyword;
a repository operable to store or provide links to a plurality of food safety courses or content;
an end user database secured by blockchain technology, the end user database operable to store end user records; and
the analytics engine operable to generate an end user certification based on the stored end user records, the end user certification being validated using block chain technology.
